(19) United States
(12) Patent Application Publication
(10) Pub. No.: US 2007/0192754 A1
(43) Pub. Date: Aug. 16, 2007

(54) Method for treating design errors of a layout of an integrated circuit

(76) Inventor: Markus Hofsaess, Munich (DE)

Correspondence Address: PATTERSON & SHERIDAN, LLP;Gero McClellan / Infineon / Qimonda, 3040 POST OAK BLVD.,, SUITE 1500, HOUSTON, TX, 77056, US

(21) Appl. No.: 11/354,276

(22) Filed: Feb. 14, 2006

(51) Int. Cl. G06F 17/50

(52) U.S. Cl. 716/5

(57) ABSTRACT

Embodiments of the invention provide a method for treating errors during the checking of a design of an integrated circuit. In one embodiment, the method includes checking the design of the integrated circuit for errors using predetermined design rules, wherein the design includes a plurality of cells, detecting a design error when the design deviates from the predetermined design rules, writing the design error into a design error file, wherein at least one detected design error is written into a design waiver file if the design error is allowed as an allowed design error in spite of the deviation from the predetermined rules, and storing the allowed design error in the design waiver file with specification of a cell in which the design error occurs.

### BACKGROUND OF THE INVENTION

1. Field of the Invention

The invention relates to a method for treating design errors of a layout of an integrated circuit.

2. Description of the Related Art

The dimensions of integrated circuits are continuing to decrease so that parasitic effects play an ever greater role in the functionality of the integrated circuits. To avoid unwanted parasitic effects, during the development of integrated circuits it may be desired that the layout of the masks for producing the integrated circuits be accurately checked for errors. During the checking of the layout, a design rule check may be performed in order to check whether the patterns determined in the layout correspond to the predetermined rules. An individual creation of the layout may result, in some cases, however, that errors detected with the aid of an automatic program in a comparison with the design rules are allowed, nevertheless. This may make it possible to individually adapt the layout to a desired operation and to the specified boundary conditions.

The layout is typically checked with respect to the maintenance of the design rules with the aid of automatic programs, utilizing a computing unit, and errors which are detected are stored in an error file. If then a detected error is allowed, nevertheless, a waiver file may be stored for the detected error. By comparing a detected error with the errors stored in the waiver file, allowed errors are left out during the creation of an error report or not displayed in the graphical representation on a screen, respectively. This enables only those errors which do not represent allowed errors to be displayed or output efficiently during the checking of the layout.

In some cases, recording a waiver for each error that occurs may be time consuming, e.g., to the operator of a system. Accordingly, what is needed is an improved system, computer-readable medium, and method for error-checking of a layout and/or design.

### SUMMARY OF THE INVENTION

Embodiments of the invention provide a method for treating errors during the checking of a design of an integrated circuit. In one embodiment, the method includes checking the design of the integrated circuit for errors using predetermined design rules, wherein the design includes a plurality of cells, detecting a design error when the design deviates from the predetermined design rules, writing the design error into a design error file, wherein at least one detected design error is written into a design waiver file if the design error is allowed as an allowed design error in spite of the deviation from the predetermined rules, and storing the allowed design error in the design waiver file with specification of a cell in which the design error occurs.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a diagrammatic representation of a computer system for carrying out the method according to one embodiment of the invention.

FIG. 2 shows a diagrammatic program flow for designing and producing an integrated circuit according to one embodiment of the invention.

FIG. 3 shows a diagrammatic representation of an error file for an allowed error according to one embodiment of the invention.

FIG. 4 shows a diagrammatic representation of a program for checking the layout for design errors according to one embodiment of the invention.

FIG. 5 shows a diagrammatic representation of a geometric error according to one embodiment of the invention.

FIG. 6 shows a diagrammatic representation of classes of errors according to one embodiment of the invention.

FIG. 7 shows a method for creating a waiver file according to one embodiment of the invention.

FIG. 8 shows a diagrammatic representation of a layout according to one embodiment of the invention.

FIG. 9 depicts a computer readable medium according to one embodiment of the invention.

### DETAILED DESCRIPTION OF THE PREFERRED EMBODIMENT

The invention relates to a method for treating design errors, wherein a design of an integrated circuit is checked by means of predetermined rules, wherein the design exhibits a number of cells, wherein an error is detected when the design deviates from the predetermined rules, wherein the error is written into an error file, wherein at least one detected error is written into a waiver file if the error is treated as an allowed error in spite of the deviation from the rules, wherein an allowed error is stored in the waiver file with specification of the cell in which the error occurs. Thus, in some cases, it may be possible to allocate allowed errors to a cell. Also, in some cases, it may be possible to provide increased flexibility in treating allowed errors.

In one embodiment, the method deals with layout errors, wherein a layout of an integrated circuit is checked by means of predetermined rules, wherein the layout exhibits a number of cells, wherein an error is detected when the layout deviates from the predetermined rules, wherein the error is written into an error file, wherein at least one detected error is written into a waiver file if the error is treated as an allowed error in spite of the deviation from the rules, and wherein an allowed error is stored in the waiver file with specification of the cell in which the error occurs.

In one embodiment, an error may be assigned to an error class when checking the design or the layout according to predetermined rules. Thus, the errors of the error file may be classified.

In a one embodiment, an allowed error may be divided into one of several classes in accordance with predetermined rules, with allowed errors of the different classes being treated differently during the checking of errors. For example, errors of different classes may be treated differently in dependence on a specification, for example, in an error report or during the representation of allowed errors. Thus, an allowed error of a first class may not be taken into consideration in the error report or during the representation of the allowed errors. Errors of a second class, in contrast, may be taken into consideration either in the error report and/or during the representation.

In one embodiment, errors which are identical, i.e. which, for example, exhibit an identical geometry in a layout error, are classified into the same class. Thus, it may be possible for a simplified treatment of the errors in the form of classes of errors to be provided. Thus, for example, it may be achieved by means of the specification that errors of certain classes are treated in a specified manner. Accordingly, in some cases, it may be sufficient to allocate a class to a corresponding method of treatment instead of treating each allowed error individually.

In one embodiment, an error may be allocated to the cell in which the error has occurred for the first time during the checking of the design. Thus, an unambiguous allocation of the errors may be possible. In one embodiment, the error is stored in the form of a file in which a description of the error, a specification of the cell in which the error is located, and a specification of coordinates which describe the position of the error within the cell are stored. This may make it possible to reuse the error file also in other test processes, for example cells of a higher position hierarchically.

In one embodiment, a computer readable medium containing instructions for performing the described methods is provided.

Embodiments will now be explained in greater detail with reference to the attached figures in which exemplary embodiments of the invention are shown. However, embodiments of the invention can be implemented in various embodiments and is not restricted to the embodiments explained. The operation of embodiments of the present invention, as will be explained in the text which follows, can be implemented in the form of hardware, in the form of software or in a combination of hardware and software. Furthermore, embodiments of the present invention can be implemented in the form of a computer program product on a computer-readable storage medium with computer-readable program codes on the storage medium. In one embodiment, any type of floppy disk, CD-ROM or optical or magnetic storage device may be used as computer-readable storage medium.

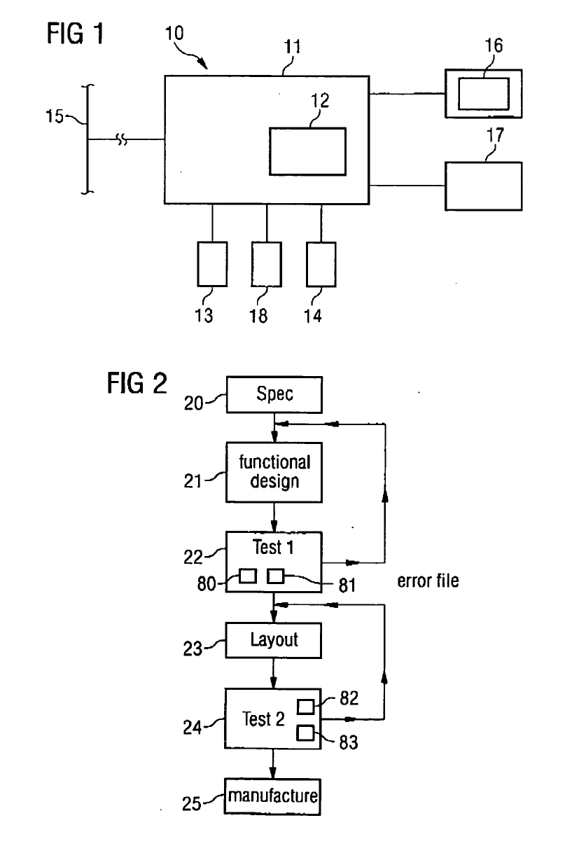

FIG. 1 is a block diagram depicting a hardware arrangement of a computer system 10 which has a checking system for integrated circuits according to one embodiment of the invention. The computer system 10 may have a computer 11 (e.g., including a processor) which has a checking program 12 which can be run by the computer 11. The checking program 12 is configured for checking an electrical structure of the integrated circuit and/or a layout of the integrated circuit. The computer system 10 may have a memory 13, a data drive 14 and/or a data bus 15. The data representing the electrical structure and/or the configuration of the layout of the integrated circuit may be supplied to the computer 11 via the memory 13, the data drive 14, or the data bus 15. Furthermore, the computer system 10 may have a display 16, a printer 17 and an input unit 18. As an example, the checking program 12 can be installed on a computer system 10 such as, e.g. an Ultraspark 5 workstation by Microsystems Computer Corporation.

FIG. 2 shows a diagrammatic structure of a program for the development, testing, and production of an integrated circuit according to one embodiment of the invention.

In a first program step 20, a specification for the electrical characteristics of the integrated circuit is created. Following this, the integrated circuit is physically designed by means of the specification, taking into consideration predetermined design rules, in a following second program step 21. During this process, a functional design of the integrated circuit may be created as structural description on a gate level or an electrical level.

In one embodiment, the functional design is checked for predetermined rules, for example, an electrically correct functionality, in a third program step 22. If it is found in the third program step 22 that the functional design has errors, these may be stored in an error file 80. Following this, a check may be made as to whether the detected error is stored in a waiver file 81. If the detected error is not stored in the waiver file 81, the program returns to the second program step 21 and the error may be corrected in the functional design.

If, however, the comparison shows that the detected error is stored as an allowed error in the waiver file 81, the detected error may be retained and not corrected in the functional design.

In one embodiment, the waiver file 81 may already be stored in the data memory 13, or, optionally, during the execution of the first checking method, an operator may be given the choice of characterizing a detected error as an allowed error in the third program step 22. If the operator characterizes a detected error as an allowed error, the allowed error is stored in the waiver file 81. The error file 80 may remain unchanged. The masking of putatively correct errors, i.e. the admission of allowed errors, may be achieved by comparing data of the error file to the waiver file.

In one embodiment, the third program step 22 may not be performed and after the second program step 21 the fourth program step 23 can be processed.

After the functional design has been checked with the first checking method in the third program step 22, the program branches to the fourth program step 23. In the fourth program step 23, a layout design for the masks used for producing the integrated circuit is created from the functional design. During this process, a physical design which contains the layouts of the masks of the integrated circuit may be produced from the functional design.

In some cases, the physical design may be subdivided into a sequence of manageable small design steps. For example, the layout may be created with the aid of a number of cells which enable the integrated circuit to be abstracted and thus the layout design to be managed, e.g. at gate level. The design of the layout of the individual gates may result in a cell library which provides the objects for the algorithms for generating the geometric layout of the overall circuit. After the cells have been specified, the available space of the integrated circuit may be subdivided into relatively large blocks. During this process, the relatively large blocks on the area may be divided in such a manner that as little area as possible is consumed. The blocks, in turn, may contain parts of the integrated circuit such as, e.g. an array of a memory chip, or connecting areas. After the placement of the cells, the connections between the cells may be established. The cells can have, for example, individual gates, individual registers, and individual counters. Depending on the embodiment, cells can also represent relatively large circuit blocks such as, e.g. DRAM memory cells, an array of memory cells, input/output units etc.

After the layout of the integrated circuit has been created in the fourth program step 23, a check is made in the following fifth program step 24 as to whether the specified layout corresponds to predetermined design rules. For this purpose, the computer 11 may have a corresponding database which is stored in the memory 13 and in which the permissible design rules, i.e. the permissible geometric patterns for the layout are stored. The design rules may depend on the respective technology which is used for producing the integrated circuit. In addition, the design rules of the individual chip manufacturers may be different. For example, design rules may relate to minimum distances between electrical tracks, minimum widths of electrical tracks, overlaps of conducting layers and inner layers of individual layers and combinations of layers.

If, during the checking of the layout, the computer 11 detects that areas of the layout do not correspond to the predetermined design rules, these may be stored in a second error file 82. In addition, a check may be made as to whether the detected error is stored in a second waiver file 83. If the check shows that the detected error is stored in second waiver file 83, the error may be treated as an allowed error. In the second waiver file 83, errors may be stored which, although they do not correspond to the design rules, are allowed, nevertheless, for other reasons. For example, the operator may desire to explicitly breach the design rules, for example, in order to achieve a desired circuit not contemplated in the design rules. The second waiver file 83 can already exist or be created by an operator during the checking of the layout. For this purpose, a detected error is indicated to the operator and the operator can store the detected error as an allowed error in the second waiver file 83. This may be possible when, although the detected error does not correspond to the design rules, it is allowed, nevertheless, by the operator.

In one embodiment, during the checking of the layout, the layout may be checked in a hierarchical structure. Thereby, in one embodiment, the checking of the layout is carried out according to a hierarchical tree of the cells, for example, in a bottom-up manner.

In one embodiment, for an allowed error, a data item (e.g., a record) may be stored in each case both in the error file and in the waiver file. The writing of a data item into the error file or the waiver file may be carried out either automatically or upon request of an operator of the computer system. The data item of the error may provide a designation of the error, the coordinates of the error in the cell in which the error has been detected, and the form of the error, for example, the type of the polygon, the number of corners and the coordinates of the polygon. In addition, the data item may provide the coordinates of the cell by means of which the cell is placed on the integrated circuit. Depending on the embodiment, the data item can also contain only individual elements thereof.

In one embodiment, if the checking of the layout shows in the fifth program step 24 that an error has been detected and the error is not stored in the second waiver file 83, the error does not represent an allowed error and is reported back to the fourth program step 23. In the fourth program step 23, the layout may be correspondingly changed in order to avoid the error.

In one embodiment, if the comparison in the fifth program step 24 shows that the detected error has already been stored in the second waiver file 83, the error is allowed as an allowed error and no change in layout may be carried out in the fourth program step 23 with regard to this error.

After the checking of the layout and the elimination of the detected and unallowable errors, the sixth program step 25 may be performed, for example, to produce an integrated circuit with corresponding semiconductor technology with the aid of the layout.

In one embodiment, a layout-versus-schematic (LVS) comparison in which the hierarchical layout is compared with the diagrammatic design may be performed in addition to the checking of the design rules. For this purpose, a hierarchical net list (e.g., connection list) of the components and nets may be created from the layout. The hierarchical net list may be compared with the electrical net list of the functional design. In this comparison as well, errors may be detected which are treated in the same manner as during the layout comparison.

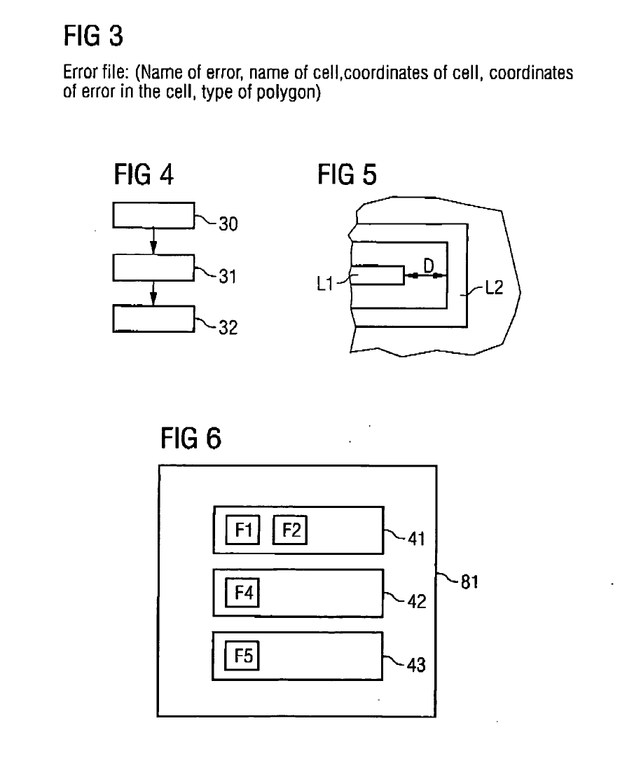

FIG. 3 shows in a diagrammatic representation a file for an error which is correspondingly stored in an error file and possibly in a waiver file according to one embodiment of the invention. The file may provide a name for the error, a name for the cell in which the error was detected, coordinates of the error, and the description of the polygon with the number of corners.

FIG. 4 shows a representation of an embodiment of the fifth program step 24 in which the layout is checked with respect to design errors according to one embodiment of the invention.

At a first program point 30, the program detects an error. In a subsequent second program point 31, the computer 11 checks whether the error can be allocated to one of a number of error classes. During this process, the computer 11 checks the error classes which are stored in the memory 13. For each class, information about the type of error class is stored in the memory 13. To characterize the type of an error, for example, geometric data may be used which represent geometric patterns. If the computer 11 finds during the check that the error can be allocated to an error class, the computer 11 assigns the error to an error class in the subsequent third program point 32 and marks the error by means of a designation for the error class.

In one embodiment, a checking routine is carried out at the second program point 31 assessing whether the same error has already been detected and whether a new error class has been established. If this is the case, the newly detected error is assigned to the same error class. If the error detected at the first program point 30 is new, a new error class is established at the second program point 32 and the error is assigned to a new error class.

In one embodiment, at the second program point 31, a check may be performed of whether the newly detected error is an allowed error. For this purpose, e.g. an error class may be stored in the memory 13 as an allowed error class. Furthermore, the newly detected error may be displayed to an operator for assessment. If the operator marks the newly detected error as an allowed error, the error may be stored in the second waiver file. Furthermore, the operator may determine that all errors assigned to an error class are allowed errors and after detection are to be stored not only in the error file, but also in waiver file.

FIG. 5 shows an example of a geometric pattern which corresponds to an error according to one embodiment of the invention. In this case, the layout may contain the error that a first conductor track L1 may be a distance D from a second conductor track L2 which is too small.

In one embodiment, an allowed error is allocated to an error class even when the allowed error does not correspond to the type of error of the error class but is still within a certain range of similarity. In the case of geometric figures, deviations of, for example, 3% in one direction may be permitted.

In one embodiment, by means of a corresponding input, the operator may cause the computer 11 to create a new error class for individual or for all errors in the memory 13 and to take it into consideration during further checking.

In one embodiment, after the second program point 31 has been processed, the subsequent third program step 32 queries what error classes of the allowed errors or what allowed errors are to be output in an error report or to be represented on the display 16 during the representation of the errors found. The corresponding classes or individual errors can be predetermined by an operator. Depending on the selected embodiment, the classes which are to be indicated or taken into consideration in the error report can already be preset. In some cases, in this manner, the error classes may be used for structuring and treating the errors in a simpler way.

FIG. 6 shows in a diagrammatic representation a waiver file 81 in which classes 41, 42, 43 for three different error types are arranged according to one embodiment of the invention. In a first class 41, a first error F1 and a second error F2 are stored. In a second error class 42, a fourth error F4 is stored. In a third error class 43, a fifth error F5 is stored. The first and the second error F1, F2 may belong to the same error class, for example, since the two errors are identical or at least have a predetermined similarity, such as, for example, predetermined geometric dimensions of a predetermined geometric pattern.

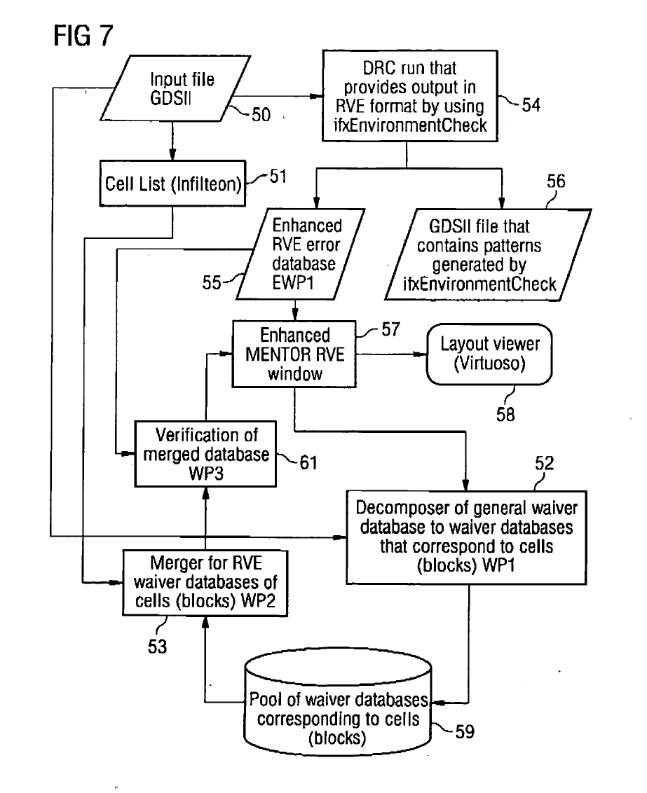

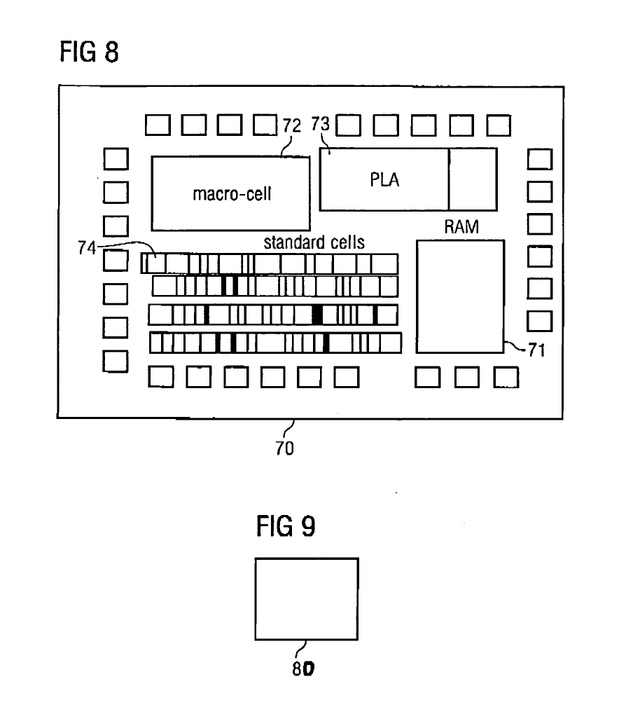

FIG. 7 shows in a diagrammatic overview a further embodiment of the method which is processed by the computer system 10 according to one embodiment of the invention. At a first program block 50, the computer 11 may be supplied with the data file for describing the geometric layout, for example, in the form of a Graphic Data System II (GDSII) format. From the data file of the first program block 50, the computer generates at a following second program block 51 a cell list, i.e. the structure and the pattern by means of which the layout of the integrated circuit was created. In one embodiment, Infilteon may be utilized to generate the cell list. FIG. 8, described in greater detail below, shows a corresponding cell structure of the layout according to one embodiment of the invention. The cell structure of the layout, in which individual cells may be positioned in cells located further up in the hierarchy, may be forwarded to a decomposer block 52 together with the information about the cells used and the structure and the hierarchy tree of the cells. In addition, the information about the cell structure, for example, with regard to the cell position in the cells located further up in the hierarchy, may be forwarded by the second program block 51 to a merger block 53.

In one embodiment, the computer 11 performs the check as to whether the layout corresponds to the predetermined design rules on the data file of the layout of the program block 51 in a processing block 54. On the basis of the errors in the layout found by the computer, the computer 11 creates an error file and a waiver file. In one embodiment, a design rule check may be run that provides output in an RVE format, for example, using ifxEnvironmentCheck. In the error file, all errors are stored which were found by the computer 11. In the waiver file, errors may be stored which represent allowable errors, i.e. which infringe the predetermined rules but, nevertheless, are retained unchanged in the layout. Moreover, in one embodiment the errors may be divided up into error classes and marked with a designation for the assigned error class. An error may be assigned to a cell in which the error first occurred during a hierarchical check. Both the error file and the waiver file may be created, for example, in Results Viewing Environment (RVE) format in a subsequent third program block 55. In addition, the computer 11 may create from the processing block 54 a sample file at a sample block 56 which stores the errors found in the form of a graphically displayable file, for example, in the GDSII format. In one embodiment, the errors found may be represented graphically on the display 16.

In one embodiment, starting at program block 55, the computing unit may create in a further processing block 57 an expanded file. Thereby, a detected error is evaluated by the operator or automatically as an allowed error, using predetermined rules. For this purpose, the allowed error may be written into a waiver file. The extended file may include the error file as well as the waiver file and can additionally be represented graphically. Starting from the further processing block 57, both the detected errors and/or the allowed errors can be represented graphically by means of the display 16 in a viewer block 58, depending on the selected program. In one embodiment, the display may be generated in a Mentor RVE window. Also, in one embodiment, the layout viewer may be Virtuoso.

In one embodiment, starting from the processing block 57, the waiver file may be converted into a waiver file for each cell, respectively, in a subsequent decomposer block 52, taking into consideration the cell structure of the layout, and stored in a waiver file. During this process, the errors detected as allowable and/or the detected errors in each case may be allocated to the cell in which the error was first found during hierarchical checking. Thus, a waiver file may be created for each cell in which errors and/or allowable errors occur.

In one embodiment, starting from the decomposer block 52, a database with all the waiver files of all layout cells may be created in a subsequent production block 59. At the subsequent merger block 53, a data file may be created from the database comprising the waiver files, the data file containing the waiver files for the cells comprised by the cell list, for which the layout check has been carried out. During this process, the structure of the layout and, for example, the hierarchical structure of the layout may be taken into consideration. In some cases, an error may only be allocated to the cell in which the error first occurred during the hierarchical check. In a subsequent fifth program block 61, a check may be made as to whether, for each error of a waiver file, an associated error exists in the error file. For this purpose, the data of the error file may be taken into consideration by the third program block 55. In one embodiment, the error file may be newly created in each check of the layout for errors. The waiver files may stem from the preceding cycles in which the layout has been checked. Thus, in one embodiment, the generated waiver files may be used more frequently. If the check shows that no corresponding error has been stored in the error file for an allowable error of the waiver file, the error may be deleted from the waiver file and a checked database for the waiver files of the individual cells may be created. The checked database may be supplied to the processing block 57. The files of the errors may structured as described, for example, in FIG. 3. By means of the described method, it may be possible to reuse waiver files, once they have been created, in a later layout check. Since a waiver file may exist for each cell and the position of each allowed error may be stored in the cell comprising the allowed error, the waiver files of the cells may be reused when checking other cells, as the position of the allowed error of one cell may be calculated for all other cells and for the layout.

Thus, in one embodiment, the data of the waiver files may be transferred to various hierarchical steps and be reused in corresponding checks of the layout. Thus, it may not be necessary to create new waiver files for each check.

FIG. 8 diagrammatically shows a layout of an integrated circuit 70 according to one embodiment of the invention. The integrated circuit 70 may include a first cell 70 which includes a second cell 71, a third cell 72, a fourth cell 73, and fifth cells 74. The first cell represents a random access memory (RAM) which, in turn, contains a multiplicity of subcells which are not shown in detail. The subcells, in turn, may contain further subcells. Depending on the layout used, the cells can be constructed as subcells up to transistor level. This results in a hierarchical structure of the cells. If then the layout of the integrated circuit 70 is tested, first the smallest subcells are tested. Following this, the cells are tested hierarchically upward which, in turn, contain the subcells. In this manner, the cell test may be performed in a hierarchical order. For each cell containing subcells, the coordinates may be stored with which the cell is positioned on the chip. In addition, the coordinates by means of which the subcells are positioned with respect to the cell may be in each case stored with respect to the cell for the subcells.

FIG. 9 depicts a computer readable medium 8 having stored thereon a computer program which, when executed, causes a computer to perform the methods described above according to one embodiment of the invention.

As described above, embodiments of the invention may provide a method for treating design errors of an integrated circuit, wherein the design of the integrated circuit is checked for errors by means of predetermined rules, wherein the design exhibits a number of cells, wherein an error is detected when the design deviates from the predetermined rules, wherein the error is written into an error file, wherein at least one detected error is written into a waiver file if the error is allowed as an allowed error in spite of the deviation from the rules, wherein an allowed error is stored in a waiver file with specification of the cell in which the error occurs.

While the foregoing is directed to embodiments of the present invention, other and further embodiments of the invention may be devised without departing from the basic scope thereof, and the scope thereof is determined by the claims that follow.

What is claimed is:

1. A method for treating errors during the checking of a design of an integrated circuit, comprising:
checking the design of the integrated circuit for errors using predetermined design rules, wherein the design includes a plurality of cells;
detecting a design error when the design deviates from the predetermined design rules;
writing the design error into a design error file, wherein at least one detected design error is written into a design waiver file if the design error is allowed as an allowed design error in spite of the deviation from the predetermined rules; and
storing the allowed design error in the design waiver file with specification of a cell in which the design error occurs.

2. The method of claim 1, further comprising:
checking a layout of the integrated circuit using predetermined layout rules, wherein the layout includes the plurality of cells; and
detecting a layout error when the layout deviates from the predetermined layout rules.

3. The method as claimed in claim 3, further comprising:
creating a layout waiver file for the plurality of cells, wherein the layout waiver file comprises allowed layout errors of the cell, and wherein the layout waiver file comprises data describing a type of the layout error, a position of the layout error in the cell, and data on a position of the cell with regard to the layout.

4. The method of claim 3, wherein the allowed layout errors of the layout which exhibit a similar or identical geometry are classified into one class.

5. The method of claim 1, further comprising:
assigning the allowed design error to a class in accordance with the predetermined design rules; and
treating allowed errors of different classes differently during the checking.

6. The method of claim 1, wherein identical errors are classified into one class.

7. The method of claim 1, further comprising:
displaying errors during the checking of the design, wherein allowed errors are not displayed during a check.

8. The method of claim 7, further comprising:
determining a class; and
displaying allowed errors of the determined class, wherein allowed errors of other classes are not displayed.

9. The method of claim 1, further comprising:
hierarchically checking the design for errors in a predetermined hierarchy of cells; and
storing the allowed design error with a reference to the cell in which the allowed error was first detected during the hierarchical checking of the design for errors.

10. The method of claim 1, further comprising:
storing an entry in the design error file for the allowed design error, wherein the entry includes a description of the design error, a specification of the cell in which the design error is located, and a specification of coordinates which describe a position of the design error within the cell and a position of the cell in a layout.

11. The method of claim 1, wherein the allowed design error is not output in an error report and is not displayed.

12. The method of 1, further comprising:
storing error files for allowed errors in a memory; and
for each of the plurality of cells, creating a waiver file which describes error files of allowed errors which are contained in the cell.

13. The method of claim 1, further comprising:
using a database with predetermined waiver files for the cells during checking of the integrated circuit, wherein the database is checked for each error of the waiver files to determine if an error is contained in the design error file, wherein the errors in the waiver files are erased to create revised waiver files if a same error is not stored in the design error file, and wherein the revised waiver files are used for displaying or reporting on the allowed design error.

14. A tangible, computer-readable medium containing instructions, which, when executed by a processor, are configured to perform method for treating errors during the checking of a design of an integrated circuit, the method comprising:
checking the design of the integrated circuit for errors using predetermined design rules, wherein the design includes a plurality of cells;
detecting a design error when the design deviates from the predetermined design rules;
writing the design error into a design error file, wherein at least one detected design error is written into a design waiver file if the design error is allowed as an allowed design error in spite of the deviation from the predetermined rules; and
storing the allowed design error in the design waiver file with specification of a cell in which the design error occurs.

15. The tangible, computer-readable medium of claim 14, wherein the method which the instructions are configured to perform further comprises:
storing an entry in the design error file for the allowed design error, wherein the entry includes a description of the design error, a specification of the cell in which the design error is located, and a specification of coordinates which describe a position of the design error within the cell and a position of the cell in a layout.

16. The tangible, computer-readable medium of claim 14, wherein the method which the instructions are configured to perform further comprises:
hierarchically checking the design for errors in a predetermined hierarchy of cells; and
storing the allowed design error with a reference to the cell in which the allowed error was first detected during the hierarchical checking of the design for errors.

17. The tangible, computer-readable medium of claim 14, wherein the method which the instructions are configured to perform further comprises:
using a database with predetermined waiver files for the cells during checking of the integrated circuit, wherein the database is checked for each error of the waiver files to determine if an error is contained in the design error file, wherein the errors in the waiver files are erased to create revised waiver files if a same error is not stored in the design error file, and wherein the revised waiver files are used for displaying or reporting on the allowed design error.

18. A computer system comprising:
a memory including a design of an integrated circuit;
a processor configured to:
check the design of the integrated circuit for errors using predetermined design rules, wherein the design includes a plurality of cells;
detect a design error when the design deviates from the predetermined design rules;
write the design error into a design error file, wherein at least one detected design error is written into a design waiver file if the design error is allowed as an allowed design error in spite of the deviation from the predetermined rules; and
store the allowed design error in the design waiver file with specification of a cell in which the design error occurs.

19. The computer system of claim 18, wherein the processor is further configured to:
store an entry in the design error file for the allowed design error, wherein the entry includes a description of the design error, a specification of the cell in which the design error is located, and a specification of coordinates which describe a position of the design error within the cell and a position of the cell in a layout.

20. The computer system of claim 18, wherein the processor is further configured to:
hierarchically check the design for errors in a predetermined hierarchy of cells; and
store the allowed design error with a reference to the cell in which the allowed error was first detected during the hierarchical checking of the design for errors.
